(19) United States
(12) Patent Application Publication
(10) Pub. No.: US 2015/0170333 A1
(43) Pub. Date: Jun. 18, 2015

(54) Grouping And Presenting Images

(71) Applicants: Yushi Jing, San Francisco, CA (US); Rohit R. Saboo, Mountain View, CA (US); David Michael Vetrano, Bloomfield, NJ (US); Henry Allan Rowley, Sunnyvale, CA (US); Meng Wang, Brookline, MA (US); Xin Yan, University Park, PA (US); Bora Cenk Gazen, Mountain View, CA (US)

(72) Inventors: Yushi Jing, San Francisco, CA (US); Rohit R. Saboo, Mountain View, CA (US); David Michael Vetrano, Bloomfield, NJ (US); Henry Allan Rowley, Sunnyvale, CA (US); Meng Wang, Brookline, MA (US); Xin Yan, University Park, PA (US); Bora Cenk Gazen, Mountain View, CA (US)

(73) Assignee: GOOGLE INC., Mountain View, CA (US)

(21) Appl. No.: 13/233,293

(22) Filed: Sep. 15, 2011

Related U.S. Application Data
(60) Provisional application No. 61/529,851, filed on Aug. 31, 2011.

(51) Int. Cl. G06T 3/40; G06F 17/30

(52) U.S. Cl. CPC G06T 3/40; G06F 17/30277

(57) ABSTRACT

This specification relates to grouping and presenting images, e.g., images corresponding to results of a search. An image visualization system is described that facilitates browsing of an image set. In some implementations, a user interface is presented with a two dimensional grid composed of images that relate to a query, where the user interface can be employed to zoom in to the search results and show more image results, or to zoom out from the search results and show fewer image results that are each representative of a group of many image results.

### CROSS REFERENCE TO RELATED APPLICATIONS

This application claims the benefit of priority from U.S. Provisional Application Ser. No. 61/529,851 entitled “GROUPING AND PRESENTING IMAGES”, filed Aug. 31, 2011.

### BACKGROUND

This specification relates to presenting images.

Information retrieval systems, for example, Internet search engines, aim to identify resources (e.g., web pages, images, text documents, multimedia context) that are relevant to a user's needs and to present information about the resources in a manner that is most useful to the user. Internet search engines return a set of search results in response to a user submitted query. The search results identify resources responsive to a user's query. The identified resources can include varying types of content including documents, text, images, video, and audio.

In some information retrieval systems, a user can perform an image search. An image search is a search for image content responsive to an input query. An image can include a static graphic representative of some content, for example, photographs, drawings, computer generated graphics, advertisements, web content, book content. An image can also include a collection of image frames, for example, of a movie or a slideshow. In addition, some image retrieval systems employ clustering techniques to group and present image results.

### SUMMARY

This specification relates to grouping and presenting images, e.g., images corresponding to results of a search. An image visualization system is described that facilitates browsing of an image set. In some implementations, a user interface is presented with a two dimensional grid composed of images that relate to a query, where the user interface can be employed to zoom in to the search results and show more image results, or to zoom out from the search results and show fewer image results that are each representative of a group of many image results.

In general, one aspect of the subject matter described in this specification can be embodied in methods that include the actions of presenting a user interface, on a display device, including images displayed in a two dimensional grid, where each of the images is assigned a two dimensional integer coordinate in the grid based on groups corresponding to similarities among the images; receiving input to zoom out from the displayed images; and modifying, responsive to the input to zoom out, at least a portion of the user interface to decrease a granularity of the two dimensional grid and replace multiple images of one of the groups with a smaller subset of the multiple images from the one group, the smaller subset including at least a single representative one of the multiple images from the one group, and the single image being displayed after the modifying as a size larger than the single image was displayed before the modifying. Other embodiments of this aspect include corresponding systems, apparatus, and computer program products.

These and other embodiments can optionally include one or more of the following features. The method can include receiving input to zoom in; and modifying, responsive to the input to zoom in, the at least a portion of the user interface increase the granularity of the two dimensional grid and replace the smaller subset of images with the multiple images of the group, including replacing the single image with a smaller version of itself. The method can also include rescaling images displayed in the two dimensional grid in accordance with a scaling factor governed by the input to zoom in and the input to zoom out; and performing the modifying, either to zoom in or to zoom out, in accordance with the scaling factor assessed with respect to a threshold.

The modifying can include performing smooth transitions between two zoom levels. The number of images displayed in the two dimensional grid at a zoom level, z, can be k̂z*k̂z, where k is an integer of at least two, and z is an integer ranging from zero, for a farthest zoomed-out level, to at least two, three, four (or more), for a closest zoomed-in level. The modifying can include aligning the two zoom levels for the transitions. The aligning can include aligning the smaller version of the single image in a zoomed-in level of the two zoom levels with the single image in a zoomed-out level of the two zoom levels. Moreover, performing the smooth transitions can include drawing images of both of the two zoom levels in the user interface, with images from the zoomed-out level drawn using transparency governed by the scaling factor.

In general, one aspect of the subject matter described in this specification can be embodied in methods that include the actions of receiving a query; providing, responsive to the query, code that causes a receiving data processing apparatus to display images that are responsive to the query in a two dimensional grid, where each of the images is assigned a two dimensional integer coordinate in the grid based on groups corresponding to similarities among the images, and decrease a granularity of the two dimensional grid, responsive to input to zoom out from the displayed images, and replace multiple images of one of the groups with a smaller subset of the multiple images from the one group, the smaller subset including at least a single representative one of the multiple images from the one group, and the single image being displayed after the granularity decrease as a size larger than the single image was displayed before the granularity decrease. Other embodiments of this aspect include corresponding systems, apparatus, and computer program products.

These and other embodiments can optionally include one or more of the following features. The method can include providing code that causes the receiving data processing apparatus to increase the granularity of the two dimensional grid, responsive to input to zoom in, and replace the smaller subset of images with the multiple images of the group, including replacing the single image with a smaller version of itself. The method can include providing code that causes the receiving data processing apparatus to: rescale images displayed in the two dimensional grid in accordance with a scaling factor governed by the input to zoom in and the input to zoom out; and transition between the increased granularity and the decreased granularity of the two dimensional grid in accordance with the scaling factor assessed with respect to a threshold.

The method can include providing code that causes the receiving data processing apparatus to perform smooth transitions between the increased granularity and the decreased granularity of the two dimensional grid. The number of images displayed in the two dimensional grid at a zoom level, z, can be k̂z*k̂z, where k is an integer of at least two, and z is an integer ranging from zero, for a farthest zoomed-out level, to at least two, three, four (or more), for a closest zoomed-in level. The method can include providing code that causes the receiving data processing apparatus to align the increased granularity version and the decreased granularity version of the two dimensional grid for the transitions. Aligning the increased granularity version and the decreased granularity version of the two dimensional grid can include aligning the smaller version of the single image in a zoomed-in level with the single image in a zoomed-out level. Moreover, performing the smooth transitions can include drawing images of both of the increased granularity and decreased granularity versions of the two dimensional grid, with images from the decreased granularity version drawn using transparency governed by the scaling factor.

Furthermore, in general, one aspect of the subject matter described in this specification can be embodied in a system including: one or more first computers, including a processor and memory device, configured to perform first operations including (i) receiving a query, (ii) receiving ranked image search results responsive to the query, the image search results each including an identification of a corresponding image resource, and (iii) grouping the image resources based on similarity; one or more second computers, including a processor and memory device, configured to perform second operations including (i) displaying the image search results in a two dimensional grid, where each of the images is assigned a two dimensional integer coordinate in the grid according to the grouping, and (ii) decreasing a granularity of the two dimensional grid, responsive to input to zoom out from the displayed images, and replace multiple images of one of the groups with a smaller subset of the multiple images from the one group, the smaller subset including at least a single representative one of the multiple images from the one group, and the single image being displayed after the granularity decrease as a size larger than the single image was displayed before the granularity decrease. Other embodiments of this aspect include corresponding apparatus, methods, and computer program products.

These and other embodiments can optionally include one or more of the following features. Grouping the image resources based on similarity can include: calculating a first n dimensions of an image feature vector using kernelized principal component analysis on a first set of images corresponding to multiple previously received queries; calculating a second m dimensions of the image feature vector using multidimensional reduction on a second set of images returned for the query; clustering the images of the second set, in accordance with the reduced image feature vector, to map the images of the second set to a two dimensional space in accordance with one or more similarities among the images of the second set; and determining, for each position in a two dimensional image grid, (i) an image from the second set that has a minimum distance between its location in the two dimensional space and the position in the two dimensional image grid, and (ii) a priority indication for each remaining image of the second set with respect to the position.

In addition, the second operations can include: increasing the granularity of the two dimensional grid, responsive to input to zoom in, and replace the smaller subset of images with the multiple images of the group, including replacing the single image with a smaller version of itself; rescaling images displayed in the two dimensional grid in accordance with a scaling factor governed by the input to zoom in and the input to zoom out; and transitioning between the increased granularity and the decreased granularity of the two dimensional grid in accordance with the scaling factor assessed with respect to a threshold. Moreover, the one or more second processors can be configured to perform the second operations by receiving code from the one or more first computers concurrently with receipt of the image search results.

Particular embodiments of the subject matter described in this specification can be implemented so as to realize one or more of the following advantages. Images can be grouped using techniques that facilitate presentation in a zoomable user interface. These techniques may address issues associated with Self-Organizing Map (SOM) and Generative Topographic Mapping (GTM) techniques. In addition, a zoomable user interface can be provided that facilitates browsing through a large number of images.

The zoomable user interface can present the image search results in a manner similar to an online map interface, where zooming in results in the display of the search results at increased granularity, and zooming out results in the display of the search results at decreased granularity. As the user zooms in to an area of the user interface showing one or more images of interest, more of the search results are presented, and specifically, more images are shown that are similar to the one or more images of interest. Note that similarity need not be assessed by only visual content, but can also include metadata or context (with appropriate user opt-in/opt-out functionality). For example, on a product search, images that are only moderately visually similar may be pushed closer together by sharing a brand and product line.

The zoomable user interface can include a two dimensional grid composed of images that relate to a query, where each of the images is assigned a two dimensional integer coordinate, and similar images are located in nearby positions. Multiple zoom levels can each have a corresponding two dimensional grid, all of which together form an image space pyramid of many images that the user can readily explore while only showing a small number of images on the display screen at any given time. This can be of particular value on devices with smaller screens, e.g., mobile phone and tablet computers. In addition, this can assist in exploring an image space where the images may be quite dissimilar from each other by showing a few representative images that span the entire image space.

The details of one or more implementations are set forth in the accompanying drawings and the description below. Other features and advantages will be apparent from the description and drawings as well as from the claims.

### BRIEF DESCRIPTION OF THE DRAWINGS

FIG. 1 is a flow diagram of an example of a method for grouping and presenting image search results.

FIG. 2 is a flow diagram of an example of a method for generating an image hierarchy.

FIG. 3A is a block diagram of an example of a clustering diagram.

FIG. 3B is a block diagram of the example of the clustering diagram of FIG. 3A narrowed to select a canonical image.

FIG. 4A is a flow diagram of an example of a method for grouping images according to similarity.

FIG. 4B is a block diagram of an example of a system for grouping images according to similarity.

FIG. 5 is a flow diagram showing an example of a process to present and modify images in a zoomable user interface.

FIGS. 6A and 6B show an example of zoom levels for a zoomable user interface.

FIG. 7 is a flow diagram of an example of a method for performing smooth transitions between two zoom levels.

FIG. 8A shows an example of aligning images between two zoom levels.

FIGS. 8B-8D show an example of using transparency to transition between two zoom levels.

FIG. 9 is a schematic diagram of an example of a system for generating, grouping and presenting image search results.

Like reference numbers and designations in the various drawings indicate like elements.

### DETAILED DESCRIPTION

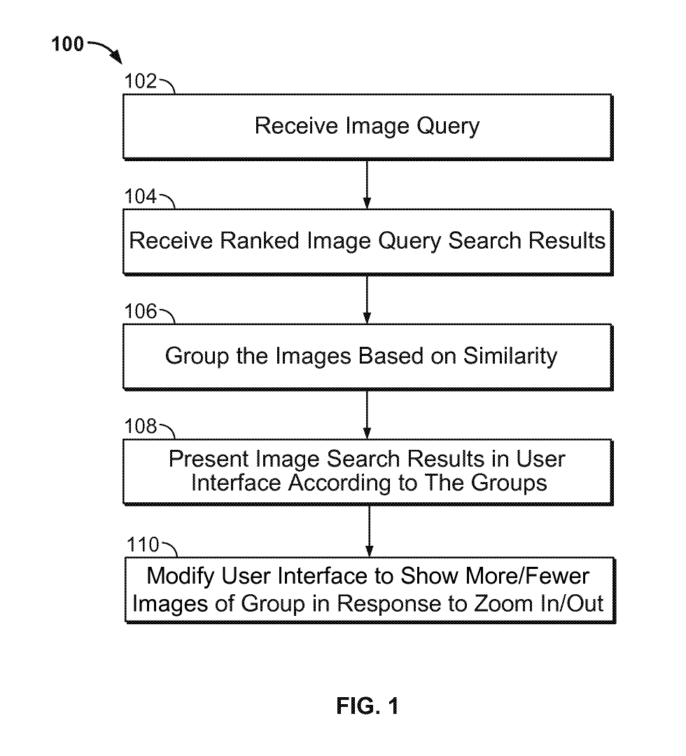

FIG. 1 is a flow diagram of an example of a method 100 for grouping and presenting image search results. Image search results generally include reduced size (e.g., thumbnail) representations of image resources that are determined to be responsive to a submitted search query. For convenience, the method 100 will be described with respect to a system (e.g., a search system), including one or more computing devices, that performs the method 100. Typically, representations of the image resources (e.g., a thumbnail) are presented rather than the actual image resources themselves, although it is possible to present the actual image resources. For convenience, the term image in the specification will refer to either an image resource or a representation of the image resource.

The system receives 102 an image query. An image query is a search query for image content responsive to the query. For example, a user can send the system a query that describes a particular image or type of image using text. The system can send the received image query to an image search engine that identifies search results. In addition, it should be noted that the image query can be preprocessed to generate search result data to be used in response to receipt of the same image query at a later time.

The image query provides information about one or more images associated with a topic, a website, a webpage, an offline database, an online database, a transaction, a document, a photograph, a drawing, or other content. The image query can include one or more query terms identifying requested image content. The query terms can identify one or more search strings (e.g., red rose bouquet, apple, bakery logo), image features (e.g., color, texture, dimension), file type (e.g., bitmap, jpeg, tiff) or a combination of the above. Moreover, in some implementations, the query itself is an image.

The system receives 104 ranked image search results responsive to the image query. The image search results identify corresponding image resources relevant to the received image query. For example, a search system can include a ranking engine that ranks image search results responsive to a received query according to one or more criteria. The system can use the ranked search results (e.g., visual information for the image resources referenced by the search results), the ranking information itself, other information (e.g., non-visual information; for example, geographical proximity, categories, pricing, etc.), or a combination of these, as an input to group images for use in a zoomable user interface, as described further below.

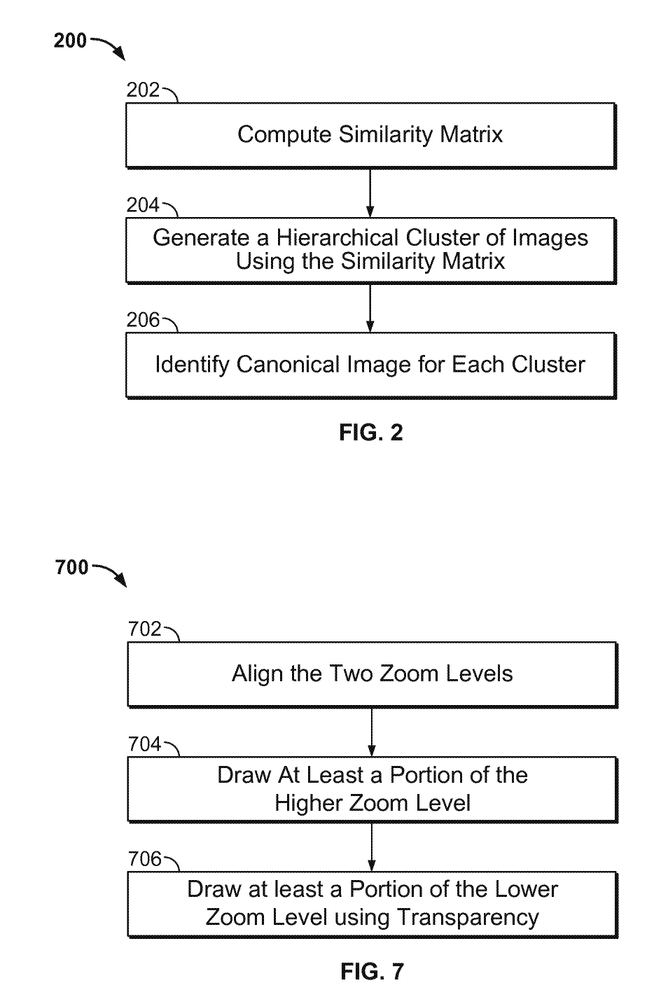

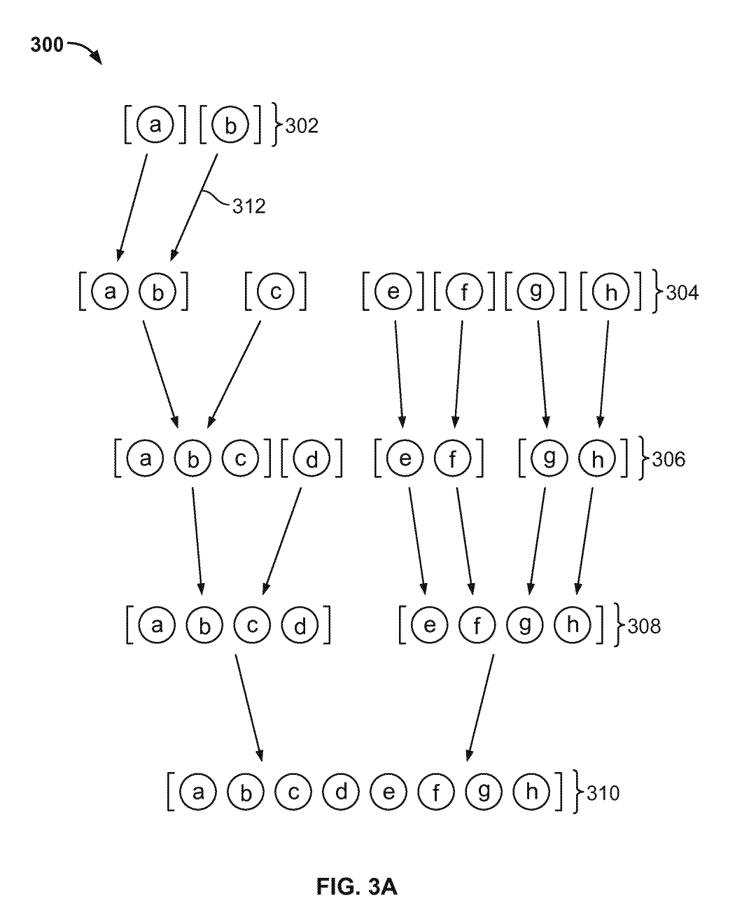

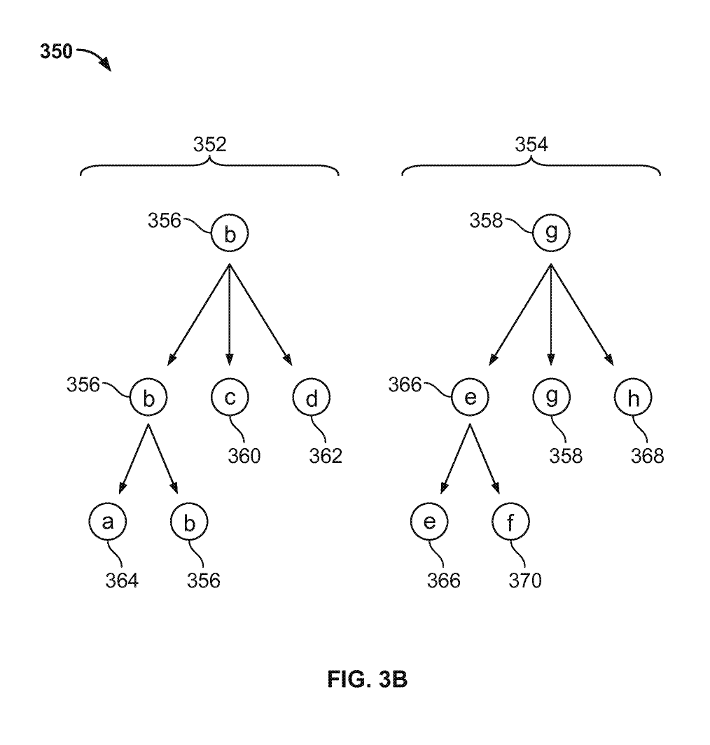

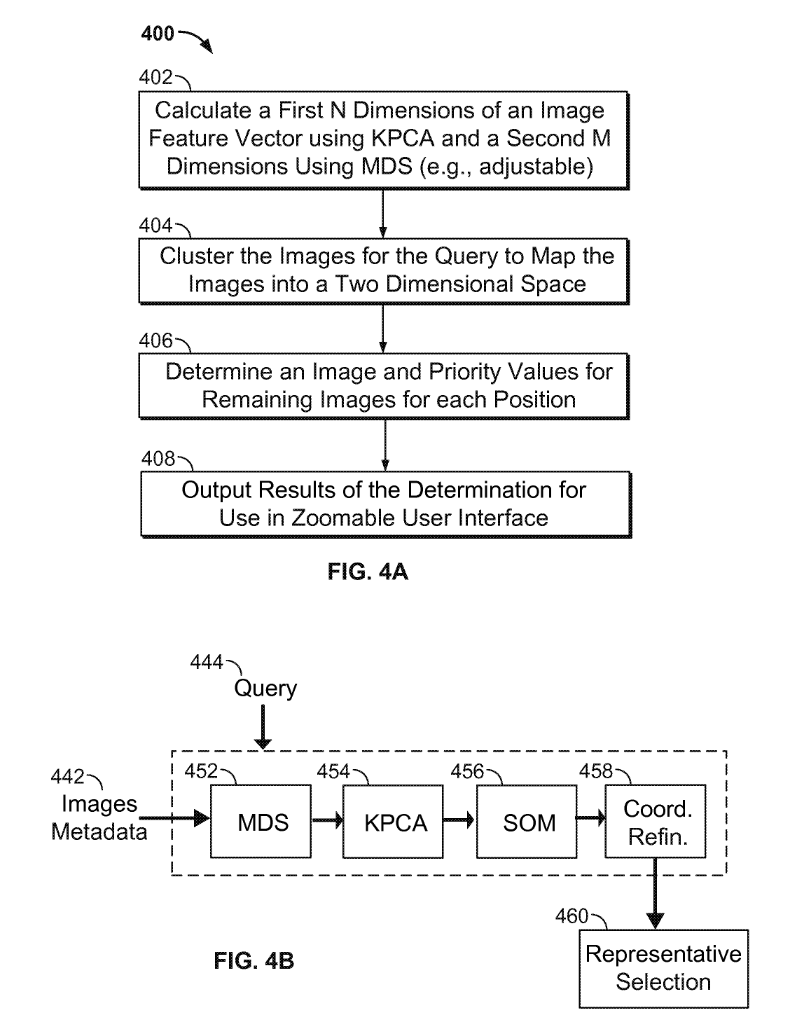

The system groups 106 the images identified in the search results based on similarities among the images. This can include grouping images using the techniques described below in connection with FIGS. 4A and 4B, or determining an image hierarchy as described below in connection with FIGS. 2, 3A and 3B. For example, the system can use clustering techniques to perform a first level grouping of the images (e.g., an initial clustering of images identified from the image search results). The first level grouping of images can include clustering data using one or more hierarchical data clustering techniques, for example, according to a similarity (visual, non-visual, or both) between images identified in the search results. In some implementations, the system uses additional external inputs when generating hierarchical image clusters. For example, the system can use data from the user's profile (with appropriate opt-in/opt-out functionality) to bias image search results when generating the hierarchical image clusters. Moreover, the results of the grouping 106 can include an indication of representative priority for each image result with respect to each group.

The system presents 108 the image search results in a user interface according to the groups. This can include making a two dimensional map by projecting a hard-clustered image hierarchy as a tree-map, or this can include automatically arranging the images in a multidimensional image array space (e.g., in a two dimensional grid) according to their similarity (e.g., visual similarity, non-visual similarity, or both). In addition, the presenting can be performed by a device at which the images are displayed, or a server device can present the user interface by sending code to a receiving device that renders the code to cause the display of the user interface being presented. Additionally, the system modifies 110 the user interface in response to input to zoom in to, and input to zoom out from, the displayed images. Upon zoom in, one more displayed images of a group are replaced to show more images from that group. Upon zoom out, fewer images from that group are displayed. Moreover, such modification can be performed by the device at which the images are displayed, on its own, using code sent by a server device in one communication session, or through ongoing interactions with a server system.

FIG. 2 is a flow diagram of an example method 200 for generating an image hierarchy. An image hierarchy can be displayed in various text-based or graphical structures. For convenience, the method 200 will be described with respect to a system, including one or more computing devices, that performs the method 200.

The system computes 202 a similarity matrix. A similarity matrix generally includes an N×N matrix of image results where each entry in the matrix is a similarity value associating two images. In particular, the images are the images identified by the search results. The similarity value represents a score identifying the similarity between a pair of images. Similarity can be calculated, for example, using color, texture, shape, or other image-based signals. In some implementations, image metadata is used in calculating similarity. For example, metadata identifying a location where or time when the image was captured, external information including text associated with the image (e.g., on a webpage), or automatically extracted metadata (e.g., facial identification). Note that some implementations will include functionality to allow users to opt-in/opt-out of having metadata used.

In some implementations, the system computes the similarity metrics according to one or more similarity metrics for the images identified by the search results. The similarity metrics can be based on features of the images. A number of different possible image features can be used including intensity, color, edges, texture, wavelet based techniques, or other aspects of the images. For example, regarding intensity, the system can divide each image into small patches (e.g., rectangles, circles) and an intensity histogram can be computed for each patch. Each intensity histogram can be considered to be a feature for the image.

Similarly, as an example of a color-based feature, the system can compute a color histogram for each patch (or different patches) within each image. The color histogram can be calculated using any known color space, e.g., the RGB (red, green, blue) color space, YIQ (luma (Y) and chrominance (IQ), or another color space. Histograms can also be used to represent edge and texture information. For example, histograms can be computed based on patches of edge information or texture information in an image.

For wavelet based techniques, a wavelet transform may be computed for each patch and used as an image feature, for example. The similarity metrics can alternatively be based on text features, metadata, user data, ranking data, link data, and other retrievable content.

The similarity metrics can pertain to a combination of similarity signals including content-based (e.g., color, local features, facial similarity, text, etc.), user behavior based (e.g., co-click information), and text based (e.g., computing the similarity between two sets of text annotations). Additionally, text metadata associated with the images can be used (for example, file names, labels, or other text data associated with the images). When using local features, the system can compute the similarity based on the total number of matches normalized by the average number of local features. The similarity matrix or other structure can then be generated for the particular one or more similarity metrics using values calculated for each pair of images.

The similarity matrix can be computed for each unique pair of images in the image search results. For example, the system can construct a similarity matrix by comparing images within a set of images to one another on a feature by feature basis. Thus, each image has a similarity value relative to each other image of the search results.

Overall, higher scores are given to more similar images and lower or negative scores are given for dissimilar images. The system can, for example, use ranked image search results returned in response to a user query to generate a similarity matrix. The similarity matrix can be symmetric or asymmetric.

The system generates 204 a hierarchical cluster of image search results using the similarity matrix and according to a particular clustering technique. In particular, the similarity value for each pair of images can be treated as a distance measure. The system can then cluster the images according to a particular threshold distance. The threshold can, for example, provide a minimum number of clusters, or a minimum acceptable similarity value, to select an image for membership to a specific cluster. Example clustering techniques are described in greater detail below. In some implementations, similar groups of images are further grouped or categorized together to increasingly larger clusters, which allows a user to gradually navigate through the layers of the hierarchy to an image of interest.

In some alternative implementations, the system generates a hierarchical cluster of images using the similarity matrix and one or more additional image similarity measures. The additional image measures can, for example, include color, texture, shape, or other image-based signals. Additionally, non-image signals can be used to provide a similarity measure including, for example, text, hyperlinks, and user interaction data.

After generating a hierarchical clustering of images using the similarity matrix, the system identifies 206 a canonical image for each cluster. For example, the system identifies which image within each image cluster to promote or designate as the representative image for that particular cluster. The selection of a canonical image for each image cluster provides a “visual summary” of the semantic content of a collection of images. The “visual summary” also provides a mechanism to navigate a large number of images quickly.

In some implementations, one or more additional clustering iterations are performed. In particular, additional clustering can be performed using only the canonical images. This provides a refined and reduced set of image results for display.

The canonical image can be selected using a combination of one or more ranking mechanisms, mathematical techniques, or graphical techniques. The system can calculate the canonical images for each image cluster using an image ranking score, for example, the ranking score provided from the search system or an alternative ranking system, e.g., a ranking derived based on links to and from the image, image tagging information, image similarity graphs, or other measures.

One example ranking mechanism includes promoting the highest ranked image from a set of image search results as the canonical image for a particular image cluster. For example, for a cluster of images x, y, and z, each image is assigned a ranking score within a set of search results as a whole (e.g., x=3, y=7, z=54). The system can use a ranking mechanism to select image “x” as the canonical image of the cluster based on it having the highest rank within that cluster.

In some implementations, the system computes an image similarity graph using image search results to determine a particular relevancy score for an image. The determined score can be used to select a canonical image for one or more of the image clusters. In general, image similarity graphs depict a graphical representation of images and their respective similarities. An image similarity graph is generated based on common features between images. The image similarity graph can provide a global ranking of images. The global ranking of images can be combined with other non-visual signals to determine the relevancy score. For example, text-based signals (e.g., hyperlinks, metadata) can be combined with visual features and graph analysis techniques to determine relevancy scores for a set of images. The canonical image can be selected based on the image of a cluster having a highest relevancy score with respect to the images in the cluster.

In some implementations, the system uses additional signals to identify a canonical image for a particular image cluster. The additional signals can include quality scores, image features, and other content based features. For example, content based features include the intensity of an image, edge based features of an image, metadata within an image, and text within an image. Other techniques of generating hierarchical image clusters and subsequently selecting respective canonical images can be used.

FIG. 3A is a block diagram of an example of a clustering diagram 300. The clustering diagram 300 can, for example, be created using the methods described in FIGS. 1 and 2 above. In general, clustering diagrams provide a graphical display of the assignment of objects into groups according to specified clustering criteria. For example, objects can be clustered according to similarity such that objects from the same group are more similar to one another and more dissimilar to objects from other groups. In some implementations, similarity is assessed according to a particular distance measuring technique using the values of the similarity matrix. One example distance measuring technique can use a rule where the similarity of two objects increases as the distance between the two objects decreases. Thus, the degree of dissimilarity of the two objects increases as the distance between the two objects increases.

In some implementations, the system implements a distance measuring scheme to provide the basis for determining a similarity calculation. For example, the system can implement a symmetric or asymmetric distance measuring techniques. Example distance measuring techniques to determine similarity include, but are not limited to, the Euclidean distance, the Manhattan distance, the maximum norm distance, the Mahalanobis distance, or the Hamming distance. In any case, similarity calculations can be used in selecting and presenting relevant image content to a user and/or search engine website.

The clustering diagram 300 is a dendrogram structure having a tree-like shape. The clustering diagram 300 illustrates an example arrangement of clusters generated by a hierarchical data clustering technique, for example, as described above. In some implementations, the system uses a combination of data clustering techniques to generate a grouping or clustering of image data. The system can implement one or more data clustering techniques including, but not limited to, hierarchical agglomerative clustering (HAC), k-medoids clustering, affinity propagation clustering, step-wise clustering, fuzzy clustering, quality threshold clustering, and graph-theoretic means clustering.

The clustering diagram 300 depicts a top row of nodes 302 that represent data (e.g., particular objects or image search results). The clustering diagram 300 also includes a number of rows 304, 306, 308, and 310 that represent both data nodes and clusters to which nodes can belong (e.g., image search results and clusters of image search results). For example, in row 304 a cluster [a, b] is shown as well as individual nodes c, e, f, g, and h. More or fewer data nodes can be included in rows 302-310. In addition, any number of external data nodes may be imported into the clustering diagram 300, for example, to form data clusters.

In the clustering diagram 300, the data nodes and data clusters are linked using arrows, as in arrow 312. The arrows between the data and the clusters generally represent a degree of similarity in that the more nodes added to a cluster the less overall similarity there is in the cluster (e.g., images a and b can be very similar and clustered together but once a less similar image c is added to the cluster, the overall similarity incrementally decreases depending on the degree of similarity between images in the cluster).

In operation, the system builds the clustering diagram 300 from a number of individual data nodes. At each iteration (e.g., row of the dendrogram), a larger cluster is assembled using one or more of the above data clustering techniques and a similarity matrix associating the images identified by the image search results. The system builds a dendrogram (or other structure) given a set of data nodes and a similarity matrix defining the similarity relationships between the nodes. For example, an initial number of data clusters can be specified by the system and membership of the images in the initial clusters is based on a similarity score in the similarity matrix. The similarity matrix and other system data can then be used to convert a particular dendrogram (or other structure) to a hierarchical display.

In some implementations, the system uses an agglomerative (e.g., bottom up) data clustering technique by representing each element as a separate image cluster and merging the separate image clusters into successively larger groups. For example, the system can employ a Hierarchical Agglomerative Clustering (HAC) technique to generate the dendrogram diagram 300. The arrows shown in the dendrogram diagram 300 indicate an agglomerative clustering technique because the arrows depict a flow of combining the data 302 and additional data into larger image clusters as the diagram 300 grows downward. In contrast, the system can use a divisive (e.g., top-down) clustering technique that can begin with an entire set of items and proceed to divide the items into successively smaller clusters.

In some implementations, the system employs composite content based image retrieval (CBIR) systems in addition to ranking systems and data clustering techniques. Composite CBIR systems allow flexible query interfaces and a diverse collection of signal sources for web image retrieval. For example, visual filters can be used to re-rank image search results. These “visual filters” are generally learned from the top 1,000 search results using probabilistic graphical models (PGMs) to capture the higher order relationship among the visual features.

As shown in FIG. 3A, the clustering diagram 300 depicts row 302 with two individual images, namely, [a] and [b]. For the initial clustering, the system uses specified similarity metrics (e.g., a similarity image graph), a similarity threshold for the metric (e.g., a distance threshold), and an associated specified number of image clusters (e.g., a minimum set of image clusters). For example, the system retrieves or calculates similarity metrics and similarity thresholds for purposes of clustering related images.

After an initial clustering is performed, the images (e.g., data nodes) [a] and [b] in row 302 can be merged using the similarity (e.g., the distance between the images). For example, the images [a] and [b] are shown merged in line 304. The images [a] and [b] can also be merged with other data in row 304 or data in another subsequent row. In some implementations, the system applies logic to ensure a minimum number of image clusters are used in the calculations and merging actions. Providing a minimum number of image clusters can ensure the calculations do not immediately reduce all images into a single cluster, for example.

The clustering technique generated image clusters shown in rows 304-310. Particularly, the system performs a first merge of image clusters to generate row 304, for example, where the images [a] and [b] are combined and images [c], [d], [e], [f], [g], and [h] are introduced. The system then generates row 306 by merging images [a], [b], and [c] and separately merging images [e] with [f] and [g] with [h]. The system also introduces a new image [d] in row 306. A similar process is performed to merge images [a], [b], [c], and [d] into cluster [a b c d] and images [e], [f], [g], and [h] into cluster [e f g h]. In a similar fashion using any number of similarity thresholds and merges, the system can generate the cluster [a b c d e f g h] in row 310. In some implementations, a single similarity threshold can be used to generate the dendrogram 300 in its entirety. In some implementations, the system continues clustering image clusters into fewer clusters according to decreasing threshold similarity values until the dendrogram structure 300 is created.

In some implementations, the system uses binary system data (e.g., data used to build a dendrogram) and domain knowledge to generate a particular clustering precision. For example, the system defines a set of minimum similarity thresholds ranging from zero to one, where one is exactly similar and zero is completely dissimilar. The system uses the similarity thresholds to “cut” the dendrogram into clusters. The “cut” operation provides a particular precision of clustering. In some implementations, the similarity threshold correlates to the distance between two images. That is, the two closest images that meet the minimum similarity threshold are generally merged. As an example, the dendrogram 300 depicts a scenario where the system determined the similarity threshold to be 0.1.

Upon completing a particular level of image clustering, the system can determine a final hierarchy by combining the dendrogram structures generated for each similarity threshold value into one dendrogram tree (not shown). The system can use the final hierarchy for each image cluster to select one image per image cluster with the highest image rank according to a particular ranking scheme (e.g., search rank or VisualRank) as the canonical image for the respective image cluster. For example, the image in each cluster with the highest ranking can be selected as the representative canonical image for each image cluster. Thus, the end result is a single canonical image representing a cluster of one or more peripheral images.

FIG. 3B is a block diagram of a narrowed clustering diagram 350. The clustering diagram 350 is an example of narrowing the dendrogram in FIG. 3A into two final image clusters 352 and 354, from which to select canonical images. As shown, the system selected an image [b] 356 as the canonical image for the image cluster 352. Similarly, the system selected the image [g] 358 as the canonical image for the image cluster 354.

The canonical images 356 and 358 can be provided in a visual presentation where each image 356 and 358 is used as a representative image of its group at a zoomed out level of the user interface, as determined by the clustering. For example, as shown in FIG. 3B, the canonical image 356 is linked to the images [c] 360, [d] 362, and itself. In addition, the image [b] 356 is linked in a lower level of the dendrogram 350 to the image [a] 364. In a similar fashion, the canonical image [g] 358 is linked to the images [e] 366, [h] 368, and itself. In addition, the image [e] 366 is linked to the image [f] 370 in a lower level of the dendrogram. In general, data clustering or other grouping techniques can be used to generate values indicating similarity among images to be displayed, which can be used to form a zoomable user interface as described further below. The similarity among the images can include non-visual similarities (e.g., shared information found in metadata for the images) as well as visual similarities (e.g., shared color and structure information found in image data for the images).

FIG. 4A is a flow diagram of an example of a method 400 for grouping images according to similarity, where two techniques are used in combination to reduce image feature vector dimensionality. A first n dimensions of an image feature vector can be calculated 402 using Kernelized Principal Component Analysis (KPCA) on a first set of images corresponding to multiple previously received queries. Further, a second m dimensions of the image feature vector can be calculated 402 using Multidimensional scaling (MDS) on a second set of images returned for a current query. In addition, reducing the image feature vector dimensionality can include using adjustable inputs, m and n, which is described further below in connection with FIG. 4B.

The images returned for the current query can be clustered 404 to map the images to a two dimensional space in accordance with one or more similarities among the images. This can include using the clustering techniques described above. This can also include using traditional clustering or grouping techniques, including potentially using multiple such techniques in combination, which is described further below in connection with FIG. 4B. In any case, for each position in a two dimensional grid, two pieces of information can be determined 406: (i) an image from the set that has a minimum distance between its location in the two dimensional (2D) space and the position in the 2D image grid, and (ii) a priority indication for each remaining image of the second set with respect to the position.

Finally, the results of the determining can be output 408 for use in a zoomable user interface. This can include sending the results directly to another portion of software, which generates the zoomable user interface. Alternatively this can include storing the results in a storage medium for later retrieval. Thus, it will be appreciated that the method 400 can be fully performed before any zoomable user interface is requested or displayed, or the method 400 can be performed concurrently with presentation of a zoomable user interface.

FIG. 4B is a block diagram of an example of a system, which is split into a front-end and a back-end, for grouping images according to similarity. For a query 444, the system can receive one thousand related images and their image feature vector. Using images metadata 442 and visual features of the images as input, a similarity matrix, A, can be calculated for these one thousand related images. The similarity should reflect semantic and visual similarities. A is a L by L matrix for L images, and a[i,j] holds the similarity value between image i and image j. MDS 452 is performed on A to generate matrix D, a lower dimensional feature vector for these L images (Multidimensional Reduction). D is a L by m matrix, where each row contains an m-dimensional feature vector of an image.

This m-dimensional feature vector is combined with an n-dimensional feature vector that is computed by KPCA 454 on a L′ image feature data set, which can contain all the images for all the available queries (e.g., L images gathered for K queries results in the L′ image feature data set, where L′=L*K). Specifically, for an image feature vector, the first n dimension can be calculated from KPCA, and the last m dimension can be obtained from MDS. By doing so, image distances on global image manifold are taken into account, where those distances would otherwise be omitted by the distance metric within a query's L image set. Note that m and n can be tuned to adjust the relative importance of the two.

SOM 456 is performed on the resulting feature vectors of the L images of the query 444. Ideally, each image should be assigned with a unique integer 2D coordinate. While SOM and GTM are excellent in grouping similar images together, they do not generate perfect arrangements, meaning that coordinates assigned to images are not unique. Both methods fall short in exactly arranging the images onto a 2D grid. Other methods, kernelized sorting for example, may not scale well to a large system that supports many users. Thus, coordinate refinement 458 is used to take the imperfect 2D arrangement and output a better arrangement.

Suppose that one has N*N images and wants to build an image grid with width=N and height=N. The resulting output of SOM is a set of N*N feature vectors X={x(1, 1), x(1, 2), x(1, 3), . . . , x(N, N)}, where x(i, j) is a k-dimensional (k is also the dimension of image feature vector from MDS) vector of a ‘neuron’ at (i, j). To assign a unique image to each unit, one can sequentially find an <image, unassigned unit> pair that has the minimum distance, and then assign that image to its corresponding unit. It turns out that this simple modification can eliminate the shortcoming of the original SOM method while generating visually appealing results.

For each position, a scalar representativeness priority is computed for each image. This priority can be used by the front-end to select 460 a representative image on a given zoom level when, for a given position, there exist several possible images which may be displayed. Examples of interfaces that use these priorities to select images are described below.

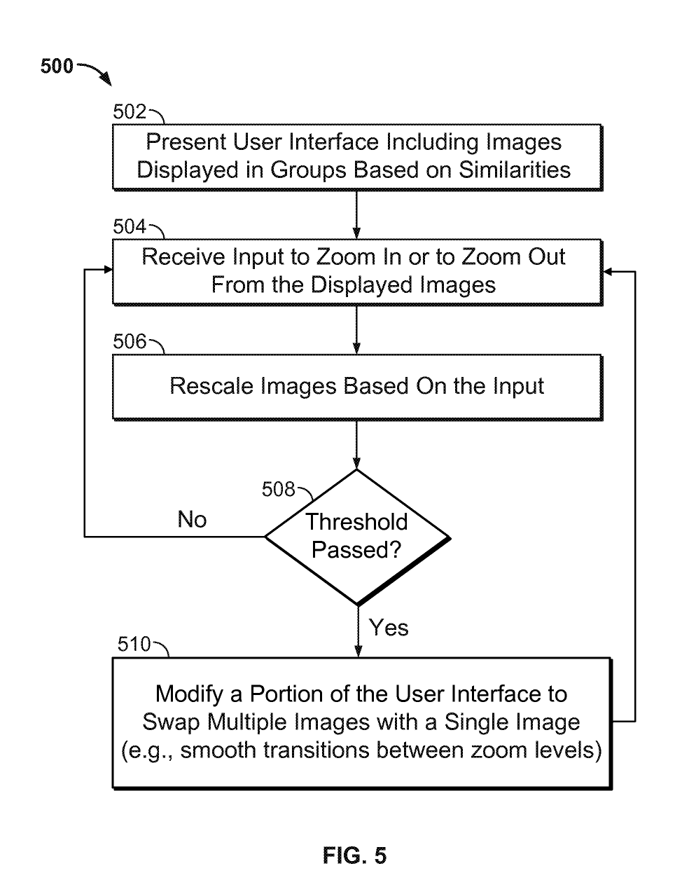

FIG. 5 is a flow diagram showing an example of a process 500 to present and modify images in a zoomable user interface. The zooming is performed (at least in part) semantically, meaning that when zooming away, fewer images are displayed, where each image represents a group of images on the higher level (the word “higher” is used here to refer to the higher zoom level, which can have a corresponding layer that is lower in a Z order of images composited in the user interface, as described further below). In addition, the following description includes rescaling of images in response to zooming in and out, but it will be appreciated that some implementations need not employ rescaling (e.g., each discrete zoom input can result in an immediate transition to a new zoom level in some implementations).

A user interface is presented 502 including images displayed in groups corresponding to similarities (visual, non-visual, or both) among the images. This can be implemented in various ways, including using JavaScript, HTML (Hypertext Markup Language), or both, in a web browser program. In addition, the canvas elements in HTML5 can be used. Thus, the implementation can be such that dependence on specific platforms or browser software can be minimized. Other implementations are also possible.

Input is received 504 to zoom in to the displayed images or to zoom out from the displayed images. As will be appreciated, several methods of interacting with the zoomable user interface are possible. On a desktop, web-based interface, the mouse scroll wheel, assigned zoom keys, or both, can be used to control the zoom input. On a touchscreen interface, e.g., used on a mobile device or tablet, zooming may be performed by the use of a single-finger or multi-finger gesture. Finally, using either a mouse or touch-based device, the zoom input can be received with reference to a region of the user interface by clicking (double or single) on an image in a specific region. This zoom input may zoom in on images in a zoom level, switch between zoom levels, or both depending on implementation. Moreover, other inputs can also be received to perform other operations in the user interface, e.g., panning. On a desktop, web-based interface, panning can be controlled using a mouse drag, using a keyboard (e.g., through use of the arrow keys), or both; on a touchscreen interface, panning can be performed with a drag gesture. In addition, in some implementations, panning during a zoom can be accomplished by selecting a new origin about which to zoom, where the position of this origin can remain constant on the screen during zoom.

Images displayed in the user interface can be rescaled 506 in accordance with a scaling factor governed by the input to zoom in and the input to zoom out. For example, a scaling factor value can be retained in memory, where the scaling factor value is directly modified in response to the zoom input, and the scaling factor can then be used to adjust the sizes of the images displayed in the user interface. As the input causes the interface to zoom in, the displayed images can be made larger until they are replaced by more images from a different zoom level. Likewise, as the input causes the interface to zoom out, the displayed images can be made smaller until are replaced by fewer images from a different zoom level.

When the scaling factor passes a threshold 508, the user interface transitions from one zoom level to another. As will be appreciated, the threshold can be an explicitly set and checked value, or the threshold can be implicit in the technique itself, e.g., in the case of the z=log₂(s) implementation described further below. During a transition between zoom levels, a portion of the user interface is modified 510 to swap multiple images with a single image, or vice versa. Thus, when the input indicates a zoom out, a portion of the user interface, which is used to show multiple images of one of the groups of images, is modified 510 to replace the multiple images in the portion of the user interface with a single image from that group of images, where the single image is representative of the multiple images of that group of images, most of which are no longer shown. Likewise, when the input indicates a zoom in, the portion of the user interface is modified 510 to replace the single image, which represents the group, with multiple images from the group. This can include replacing the single image with a smaller version of itself.

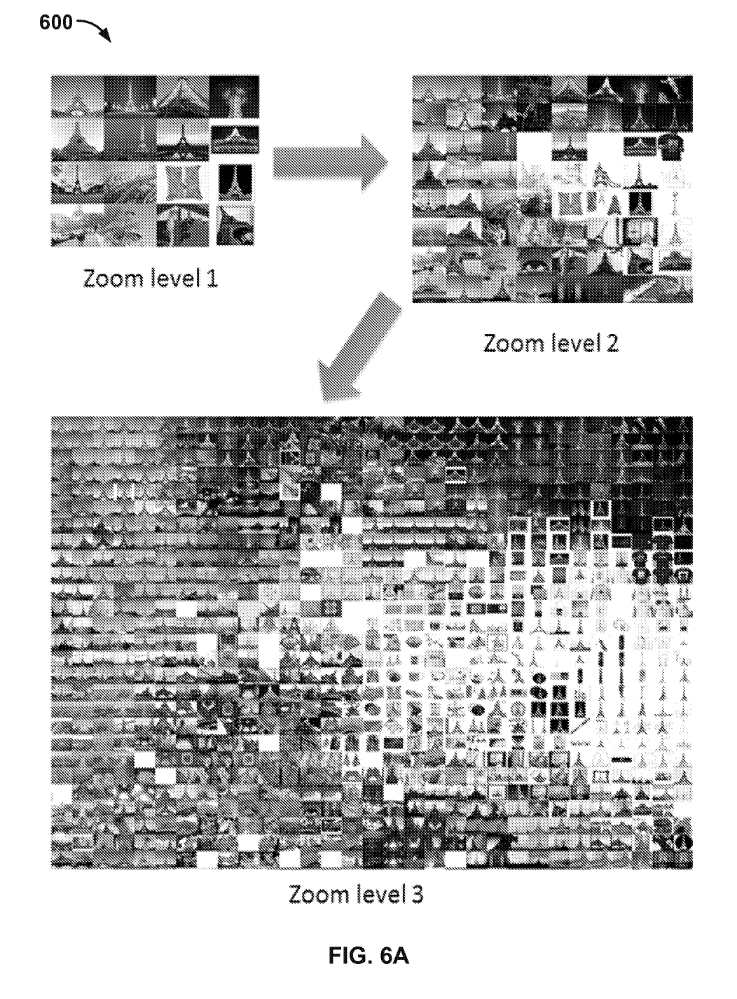

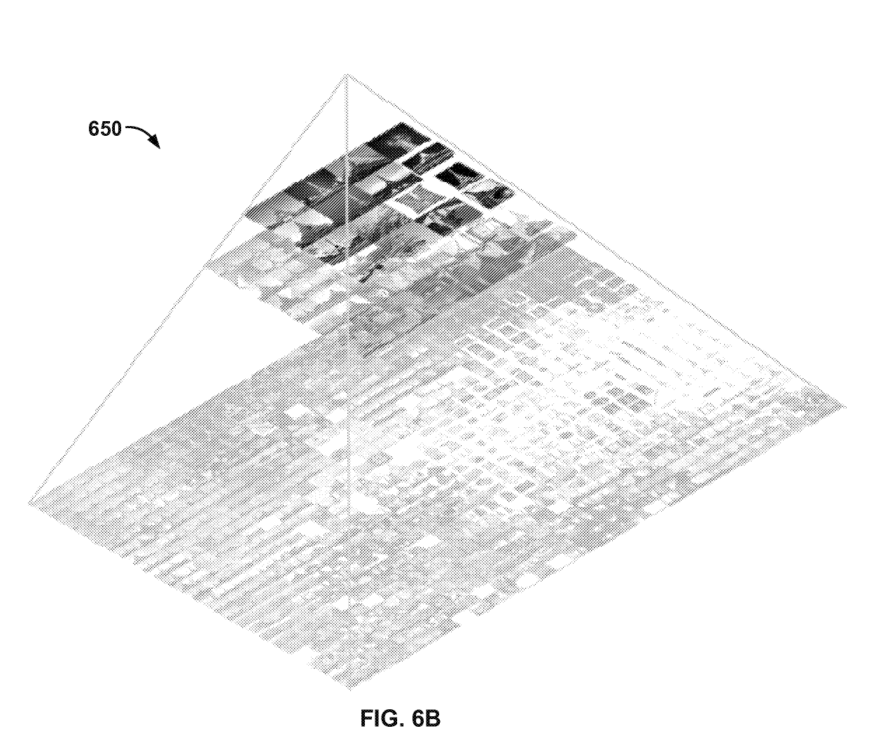

FIGS. 6A and 6B show an example of zoom levels 600 for a zoomable user interface. As shown in FIG. 6A, zoom level 1 includes sixteen images returned in response to the query “Eiffel Tower”. Each of the sixteen images in zoom level 1 is representative of a group of images, most of which are not shown. Each of the sixteen images in zoom level 1 is different, even though they are responsive to the query. Once the user zooms into the displayed images by a predefined amount, zoom level 1 is replaced with zoom level 2, which shows sixty four images, including smaller versions of the sixteen images from zoom level 1.

FIG. 6A shows all of the images in zoom level 2. However, in some implementations not all of these images will be visible on the screen at one time. For example, a user can zoom in to a portion of the images in zoom level 1 (e.g., image [3,3] in zoom level 1, when considering the columns of the image grid as 1-4 and the rows of the image grid as 1-4). When the transition is made to zoom level 2, the user interface may only show a portion of the images on that level in the display, where the portion corresponds to the group(s) zoomed into from zoom level 1 (e.g., the sixteen images [4,4], [4,5], [4,6], [4,7], [5,4], [5,5], [5,6], [5,7], [6,4], [6,5], [6,6], [6,7], [7,4], [7,5], [7,6] and [7,7] in zoom level 2, when considering the columns of the image grid as 1-8 and the rows of the image grid as 1-8). Likewise, when the user zooms in to a portion of the images in zoom level 2 (e.g., image [6,5]) and the transition is made to zoom level 3, the user interface may only show a portion of the images on that level in the display, where the portion corresponds to the group(s) zoomed into from zoom level 2 (e.g., the sixteen images [19,15], [19,16], [19,17], [19,18], [20,15], [20,16], [20,17], [20,18], [21,15], [21,16], [21,17], [21,18], [22,15], [22,16], [22,17] and [22,18] in zoom level 3, when considering the columns of the image grid as 1-31 and the rows of the image grid as 1-27). Of course, the user can still pan the images in the display, and thus all of the images in zoom level 3 are available through the user interface. Moreover, after panning to a different portion of a zoom level, the user can zoom in or out from that new position in the image space as well. In addition, in some implementations, while zooming in and out, the position of an input device (e.g., the mouse pointer) can be used to determine the panning of the next zoom level (both up and down).

As will be appreciated, there are many possible implementations of this zoomable user interface, including different ways for a user to navigate through the user interface and different ways to construct the user interface. The implementations that are described below include using different layers of an image stack to implement the different zoom levels of the user interface, but it will be appreciated that other types of implementations are also possible, including implementations where the “layers” are simply notional, rather than actual separate layers of image data stored in memory. The zoom levels form (at least conceptually) an image space pyramid 650, as shown in FIG. 6B, that enables a user to readily find a specific image sought in a large set of images retrieved. The lowest level of this pyramid 650 (which is the highest zoom level) can include all the image search results, and each successively higher level of the pyramid 650 (each successively lower zoom level) includes a proper subset of the images from the previous level, where the images of that proper subset are representative of the images from the previous level that are not in the proper subset.

In some implementations, two zoom level layers are maintained at any given time, and the two layers are drawn with one on top, overlapping the other on the bottom, within the user interface. When the user zooms, the size of images can be rescaled by multiplying a scale parameter s. Another parameter z=log k(s), for k>1, can be used to represent the current zooming level so that when s is multiplied by k, z will increase by 1. In such implementations, a selection can be made to set k=2 (other setting are also possible). At a certain zooming level z, the top level draws a matrix of k̂z*k̂z images, and the bottom level draws k̂(z+1)*k̂(z+1) images, with each image half in size of those on the top layer. In order to select images for all by the lowest layer, where ambiguity can exist, an image can be chosen for layer i such that the image from the layer (i+1) is selected from at most k*k images with the highest priority. As will be appreciated, other implementations are also possible, including implementations where zooming in replaces a single image with a non-integral number of images; for example, zooming in can cause a transition from a 2 by 2 grid to a 3 by 3 grid. Moreover, other methods can be used to choose when to transition between layers, for example, a transition between layers can be triggered when the image, toward which the use is zooming in, exceeds a predefined fraction of the screen size or an absolute size on the display (e.g., in the case of implementations for mobile devices and tablet computers).

FIG. 7 is a flow diagram of an example of a method 700 for performing smooth transitions between two zoom levels. The two zoom levels are aligned 702 for the transition. This can include shifting a higher zoom level (i.e., the zoom level having more images) relative to an overlying lower zoom level (i.e., the zoom level having fewer images) to match up one or more images on the higher zoom level with one or more images in the lower zoom level. This can help in making clear the connection between the two different zoom levels and also ease the transition between the two zoom levels for the viewer.

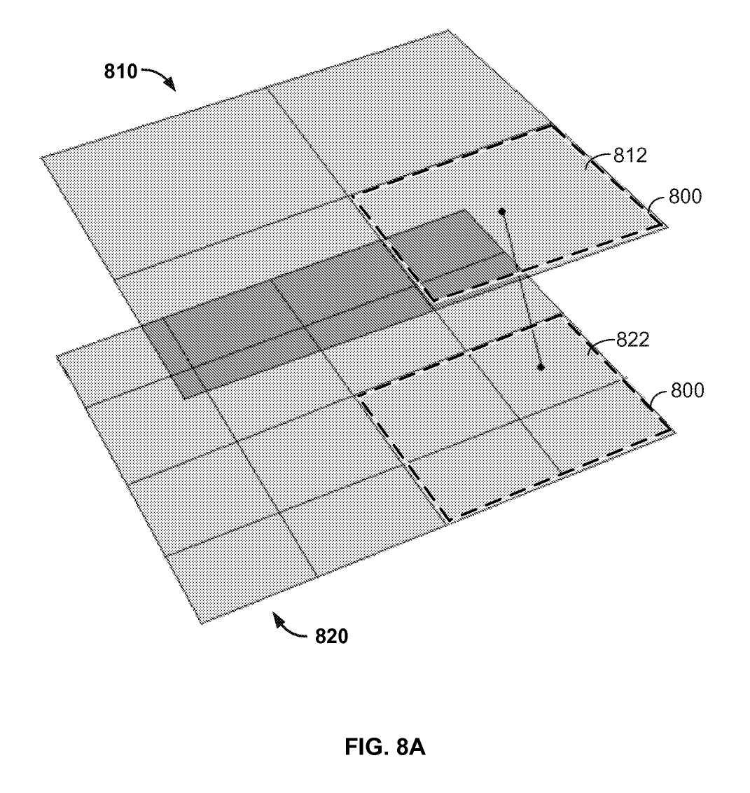

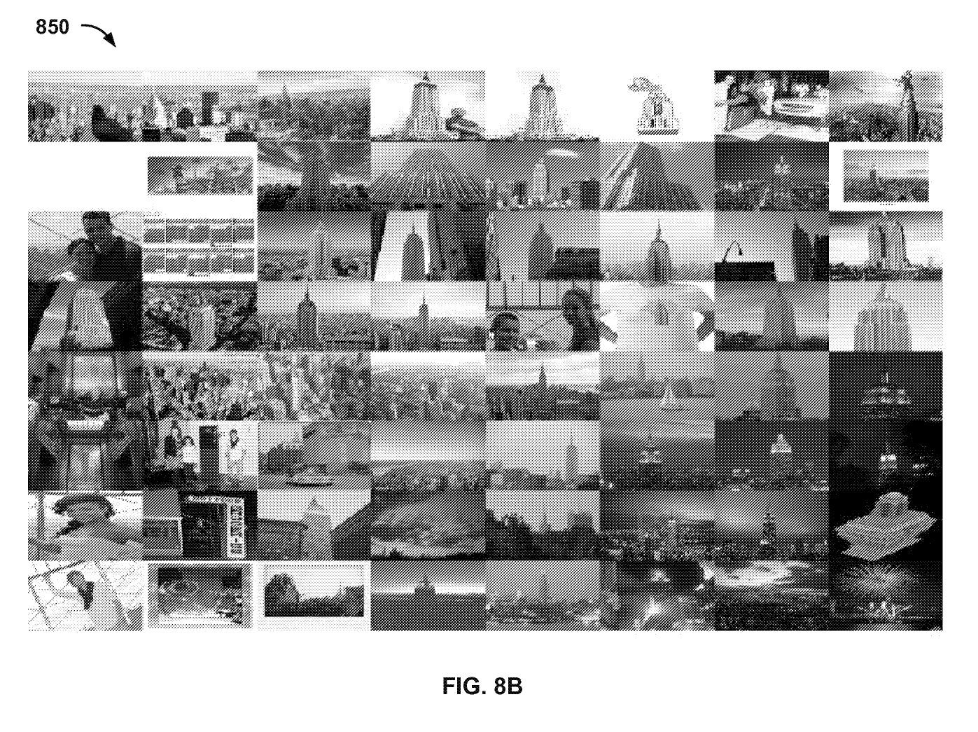

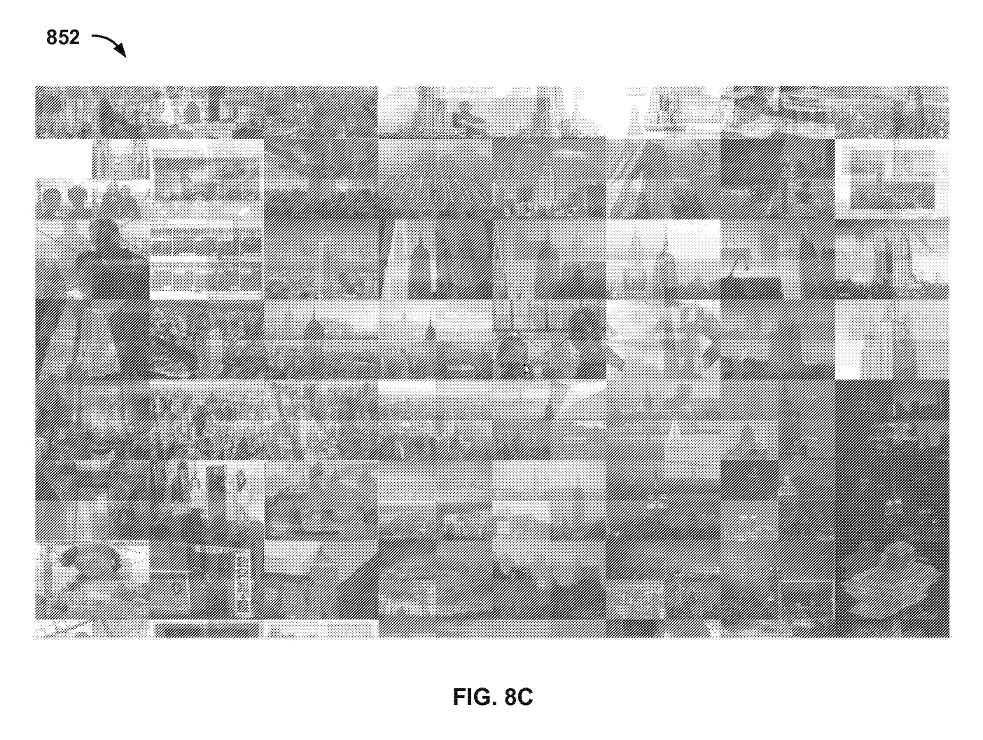

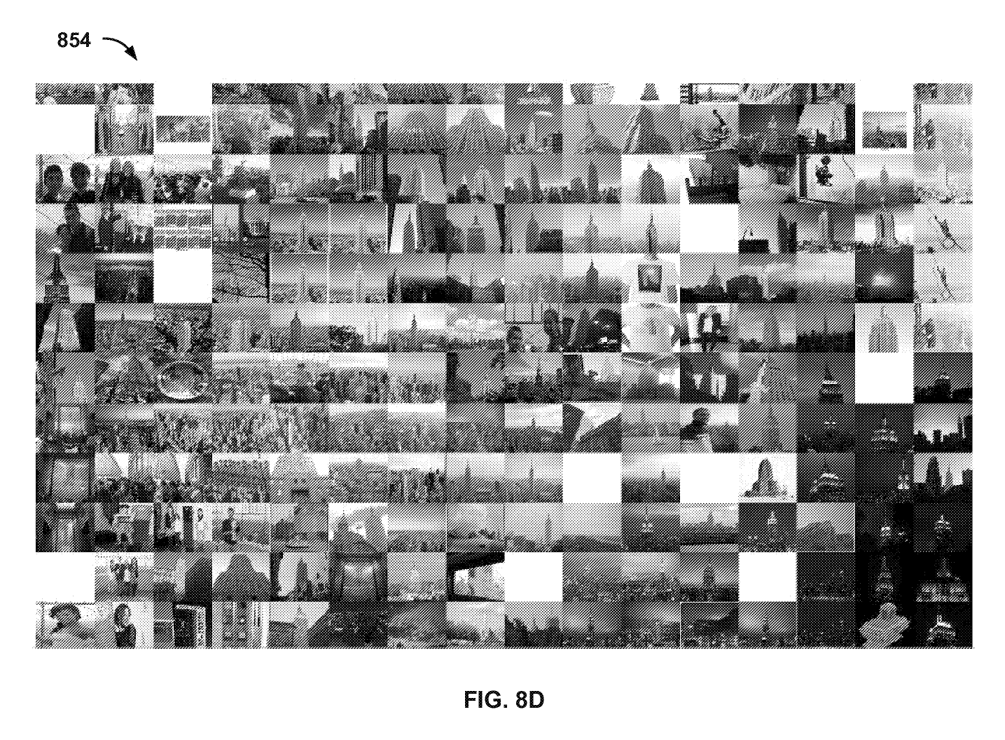

FIG. 8A shows an example of aligning images between two zoom levels. A first zoom level 810 includes four images, including an image 812 that represents a grouping 800 of images found in a search. A second zoom level 820 includes sixteen images, including four images representing the grouping 800, where one of these four images is an image 822 that is a smaller version of the image 812. When transitioning between the zoom levels 810, 820 being displayed, an alignment can be performed between the zoom levels 810, 820 (e.g., shifting/translating the second zoom level with respect to the first zoom level) such that the representative image 812 on the first zoom level 810 aligns with the corresponding image 822 on the second zoom level 820. Such shifting of the levels relative to each other at the beginning of a transition between levels causes the representative image (e.g., that with the highest priority) to be immediately below the corresponding image on the zoomed-out level, which can ensure that the display remains centered over the same image during zooming to facilitate the user's interaction with the images presented in the user interface.

Referring again to FIG. 7, at least a portion of the higher zoom level is drawn 704. This can include drawing the images for the portion of the higher zoom level in a grid, without any transparency, into a display buffer. In addition, at least a portion of the lower zoom level is drawn 706 over the higher zoom level portion using transparency. This can include drawing the images for the portion of the lower zoom level in a grid, over the higher zoom level's grid, using transparency governed by a scaling factor governed by the input to zoom in and the input to zoom out. However, use of a scaling factor as described above is just an example of a method by which a region may be specified.

For example, when zooming in, the transparency of a top layer (corresponding to the lower zoom level) can be decreased gradually, allowing images on a bottom layer show up gradually. FIGS. 8B-8D show an example of using transparency to transition between two zoom levels. Before the transition begins, a top layer 850 is drawn in the user interface without any transparency. As the transition proceeds, this top layer 850 is drawn with ever increasing transparency, thereby causing the user interface to display an image 852 that is a blend of the top layer 850 and a bottom layer 854. Once the transparency reaches 100%, only the bottom layer 854 is visible in the display of the user interface, and the transition to the new level is complete.

Various approaches can be taken to create this smooth transition using transparency. In some implementations, a log transform is used to make the transferring visually smooth: α=log 2(s)−[log 2(s)]. Other monotonically increasing functions may be used as well. When of the top level decrease to 0, z increases by 1 and there are k̂2 times more images visible than were previously visible on the top layer. The process of zooming out can be implemented in similar fashion. Thus, the whole zooming transformation can be made visually smooth so that the user may be readily aware of the relationship between images in top and bottom layers.

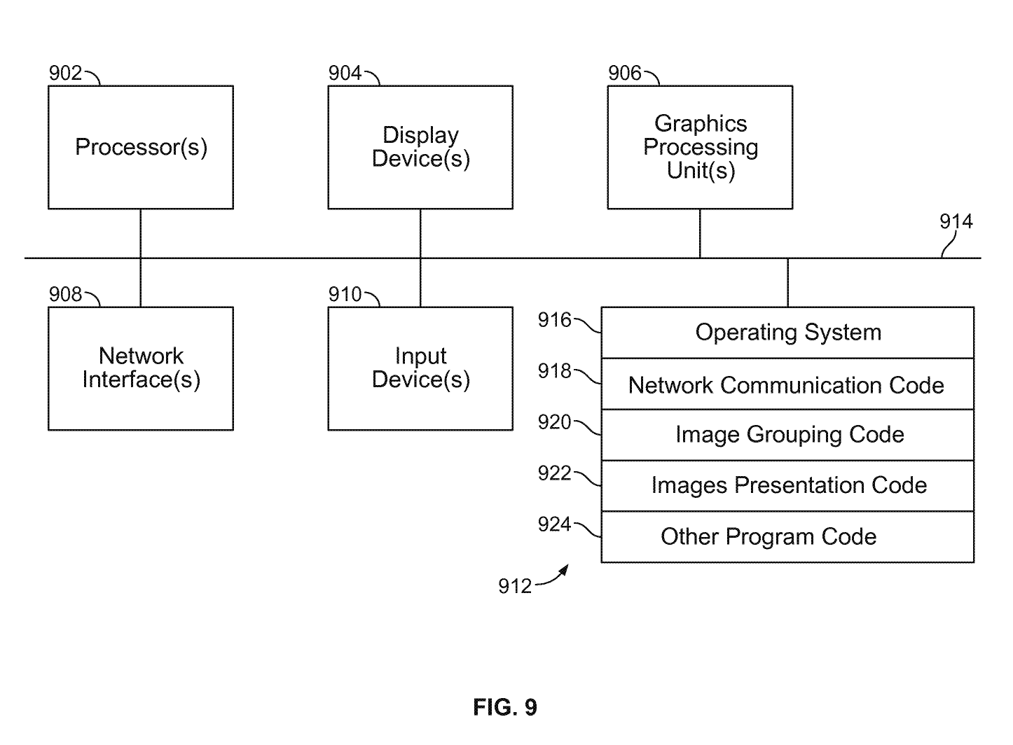

FIG. 9 is a schematic diagram of an example of a system for generating, grouping and presenting image search results. The system includes one or more processors 902, one or more display devices 904 (e.g., CRT, LCD), graphics processing units 906, a network interface 908 (e.g., Ethernet, FireWire, USB, etc.), input devices 910 (e.g., keyboard, mouse, etc.), and one or more computer-readable mediums 912. These components exchange communications and data using one or more buses 914 (e.g., EISA, PCI, PCI Express, etc.).

The term “computer-readable medium” refers to any non-transitory medium that participates in providing instructions to a processor 902 for execution. The computer-readable medium 912 further includes an operating system 916, network communication code 918, image grouping code 920, images presentation code 922, and other program code 924.

The operating system 916 can be multi-user, multiprocessing, multitasking, multithreading, real-time and the like. The operating system 916 performs basic tasks, including but not limited to: recognizing input from input devices 910; sending output to display devices 904; keeping track of files and directories on computer-readable mediums 912 (e.g., memory or a storage device); controlling peripheral devices (e.g., disk drives, printers, etc.); and managing traffic on the one or more buses 914. The network communications code 918 includes various components for establishing and maintaining network connections (e.g., software for implementing communication protocols, e.g., TCP/IP, HTTP, Ethernet, etc.).

The image grouping code 920 can provide various software components for performing the various functions for grouping image search results, which can include clustering or otherwise assessing similarity among images, such as described above in connection with FIGS. 2, 4A and 4B. The images presentation code 922 can provide various software components for performing the various functions for presenting and modifying a user interface showing the image search results, which can include the various techniques described above in connection with FIGS. 5-8D. Moreover, as will be appreciated, in some implementations, the system of FIG. 9 is split into a client-server environment, where one or more server computers include hardware as shown in FIG. 9 and also the image grouping code 920, code for searching and indexing images on a computer network, and code for generating image results for submitted queries, and where one or more client computers include hardware as shown in FIG. 9 and also the images presentation code 922, which can be pre-installed or delivered in response to a query (e.g., an HTML page with the code 922 included therein for interpreting and rendering by a browser program).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, other approaches can be used to determine the two dimensional organization of the images. Rather than generating a MDS map for one query, as described above in connection with FIGS. 4A and 4B, some implementations can collect a set of images from a collection of multiple queries and generate MDS for these images; such sets of queries can be semantically related, visually related, or both. Some implementations can employ different types of layouts (e.g., a three dimensional display of images, e.g., can be implemented using webGL or other web-based 3D rendering techniques to show images on 3D surfaces), a differently shaped canvas (e.g., a star or triangle), or both. The systems and techniques described here can be applied to videos or other visual contents, and they can also be applied to various source of images, irrespective of any image search or images search results, e.g., a photo album (either in the cloud or on the user's computer), stock photo collections, or any other image collections.

Furthermore, the hierarchical navigation can be implemented in various ways, e.g., opening a folder of images, explicit hierarchical clustering, etc. Instead of or in addition to using alpha-fading, other transition techniques can be used; this can include animation (e.g., the zoom in can be shown as though one is progressing through layers, where a top layer peels off, and new images show up in a layer below it) and also skewing the images and modifying their relative locations and sizes (even on a single layer) to create a smoother effect during zooming. Moreover, other techniques may be used to create a smooth transition between levels. For example, the zoom in to layers may be set at a different rate, when two are visible, in order to create the effect that the bottom layer comes in from behind the top layer. In such a case, clusters of size at most k*k images increase in size and opacity until they replace the top-most image. Other implementations are also possible and within the scope of the following claims.

What is claimed is:

1. A method comprising:
presenting a user interface, on a display device, including a plurality of images displayed in a two dimensional grid, where each of the images is assigned a two dimensional integer coordinate in the grid based on groups of images corresponding to similarities among the images, and wherein the images are presented in response to a search query;
responsive to receiving an input to zoom out from the displayed images presented in the user interface:
determining an image zoom level in accordance with the input to zoom out; and
modifying, responsive to the determined image zoom level, at least a portion of the user interface, wherein modifying includes:
decreasing a granularity of the two dimensional grid such that the grid includes two dimensional integer coordinates for displaying fewer images than the plurality of images, and
replacing multiple images of each group of images with a smaller subset of the multiple images from the respective group, wherein
the smaller subset, for each group, includes a predefined number of images selected from the respective group;
the predefined number is determined based on the determined image zoom level;
the predefined number is more than one, but less than the total number of the multiple images within the respective group;
the smaller subset comprises an image that is representative of the multiple images from the respective group, and
the image being displayed after the modifying has a size that is larger than the size of the image as displayed before the modifying.

2. The method of claim 1, comprising:
receiving input to zoom in; and
modifying, responsive to the input to zoom in, the at least a portion of the user interface increase the granularity of the two dimensional grid and replace the smaller subset of images with the multiple images of the group, including replacing the single image with a smaller version of itself.

3. The method of claim 2, comprising:
rescaling images displayed in the two dimensional grid in accordance with a scaling factor governed by the input to zoom in and the input to zoom out; and
performing the modifying, either to zoom in or to zoom out, in accordance with the scaling factor assessed with respect to a threshold.

4. The method of claim 3, wherein the modifying comprises performing smooth transitions between two zoom levels.

5. The method of claim 4, wherein the number of images displayed in the two dimensional grid at a zoom level, z, is k̂z*k̂z, where k is an integer of at least two, and z is an integer ranging from zero, for a farthest zoomed-out level, to at least three, for a closest zoomed-in level.

6. The method of claim 4, wherein modifying, responsive to the input to zoom in, comprises aligning the two zoom levels for the transitions.

7. The method of claim 6, wherein the aligning comprises aligning the smaller version of the single image in a zoomed-in level of the two zoom levels with the single image in a zoomed-out level of the two zoom levels.

8. The method of claim 4, wherein performing the smooth transitions comprises drawing images of both of the two zoom levels in the user interface, with images from the zoomed-out level drawn using transparency governed by the scaling factor.

9. A non-transitory computer storage medium encoded with a computer program, the program comprising instructions that when executed by data processing apparatus cause the data processing apparatus to perform operations comprising:
receiving a query;
providing, responsive to the query, code that causes a receiving data processing apparatus to:
present a user interface, the user interface displaying images that are responsive to the query in a two dimensional grid, where each of the images is assigned a two dimensional integer coordinate in the grid based on groups corresponding to similarities among the images, and
determine an image zoom level in accordance with an input to zoom out from the displayed images;
decrease a granularity of the two dimensional grid, responsive to the input to zoom out from the displayed images, such that the grid includes two dimensional integer coordinates for displaying fewer images than the plurality of images and
replace multiple images of each group of images with a smaller subset of the multiple images from the respective group, wherein
the smaller subset, for each group, includes a predefined number of images selected from the respective group;
the predefined number is determined based on the determined image zoom level;
the predefined number is more than one, but less than the total number of the multiple images within the respective group;
the smaller subset comprises an image that is representative of the multiple images from the respective group, and
the image being displayed after the modifying has a size that is larger than the size of the image as displayed before the modifying.

10. The computer storage medium of claim 9, the operations comprising providing code that causes the receiving data processing apparatus to increase the granularity of the two dimensional grid, responsive to input to zoom in, and replace the smaller subset of images with the multiple images of the group, including replacing the single image with a smaller version of itself.

11. The computer storage medium of claim 10, the operations comprising providing code that causes the receiving data processing apparatus to:
rescale images displayed in the two dimensional grid in accordance with a scaling factor governed by the input to zoom in and the input to zoom out; and
transition between the increased granularity and the decreased granularity of the two dimensional grid in accordance with the scaling factor assessed with respect to a threshold.

12. The computer storage medium of claim 11, the operations comprising providing code that causes the receiving data processing apparatus to perform smooth transitions between the increased granularity and the decreased granularity of the two dimensional grid.

13. The computer storage medium of claim 12, wherein the number of images displayed in the two dimensional grid at a zoom level, z, is k̂z*k̂z, where k is an integer of at least two, and z is an integer ranging from zero, for a farthest zoomed-out level, to at least three, for a closest zoomed-in level.

14. The computer storage medium of claim 12, the operations comprising providing code that causes the receiving data processing apparatus to align the increased granularity version and the decreased granularity version of the two dimensional grid for the transitions.

15. The computer storage medium of claim 14, wherein aligning the increased granularity version and the decreased granularity version of the two dimensional grid comprises aligning the smaller version of the single image in a zoomed-in level with the single image in a zoomed-out level.

16. The computer storage medium of claim 12, wherein performing the smooth transitions comprises drawing images of both of the increased granularity and decreased granularity versions of the two dimensional grid, with images from the decreased granularity version drawn using transparency governed by the scaling factor.

17. A system comprising:
one or more first computers, comprising a processor and memory device, configured to perform first operations comprising (i) receiving a query, (ii) receiving ranked image search results responsive to the query, the image search results each including an identification of a corresponding image resource, and (iii) grouping the image resources based on similarity;
one or more second computers, comprising a processor and memory device, configured to perform second operations comprising:
(i) presenting a user interface, the user interface displaying the image search results in a two dimensional grid, where each of the images is assigned a two dimensional integer coordinate in the grid according to the grouping, and
(ii) determine an image zoom level in accordance with an input to zoom out from the displayed images;
(iii) decreasing a granularity of the two dimensional grid, responsive to input to zoom out from the displayed images, such that the grid includes two dimensional integer coordinates for displaying fewer images than the plurality of images; and
(iv) replacing multiple images of each group of images with a smaller subset of the multiple images from the respective group, wherein
the smaller subset, for each group, includes a predefined number of images selected from the respective group;
the predefined number is determined based on the determined image zoom level;
the predefined number is more than one, but less than the total number of the multiple images within the respective group;
the smaller subset comprises an image that is representative of the multiple images from the respective group, and
the image being displayed after the modifying has a size that is larger than the size of the image as displayed before the modifying.

18. The system of claim 17, wherein grouping the image resources based on similarity comprises:
calculating a first n dimensions of an image feature vector using kernelized principal component analysis on a first set of images corresponding to multiple previously received queries;
calculating a second m dimensions of the image feature vector using multidimensional reduction on a second set of images returned for the query;
clustering the images of the second set, in accordance with the reduced image feature vector, to map the images of the second set to a two dimensional space in accordance with one or more similarities among the images of the second set; and
determining, for each position in a two dimensional image grid, (i) an image from the second set that has a minimum distance between its location in the two dimensional space and the position in the two dimensional image grid, and (ii) a priority indication for each remaining image of the second set with respect to the position.

19. The system of claim 17, wherein the second operations comprise:
increasing the granularity of the two dimensional grid, responsive to input to zoom in, and replace the smaller subset of images with the multiple images of the group, including replacing the single image with a smaller version of itself;
rescaling images displayed in the two dimensional grid in accordance with a scaling factor governed by the input to zoom in and the input to zoom out; and
transitioning between the increased granularity and the decreased granularity of the two dimensional grid in accordance with the scaling factor assessed with respect to a threshold.

20. The system of claim 17, wherein the one or more second processors are configured to perform the second operations by receiving code from the one or more first computers concurrently with receipt of the image search results.
